(19) United States
(12) Patent Application Publication
(10) Pub. No.: US 2024/0286842 A1
(43) Pub. Date: Aug. 29, 2024

(54) AN ACCESS STATION FOR AN AUTOMATED STORAGE AND RETRIEVAL SYSTEM

(71) Applicant: Autostore Technology AS, Nedre Vats (NO)

(72) Inventor: Amund Skålerud, Etne (NO)

(73) Assignee: Autostore Technology AS, Nedre Vats (NO)

(21) Appl. No.: 18/574,555

(22) PCT Filed: Jun. 24, 2022
(86) PCT No.: PCT/EP2022/067311

§ 371 Date: Dec. 27, 2023

(30) Foreign Application Priority Data
Jun. 30, 2021 (NO) 20210849

(51) Int. Cl. B65G 1/137; A47B 88/60; B65G 1/04; B65G 1/06

(52) U.S. Cl. CPC B65G 1/1378; A47B 88/60; B65G 1/0464; B65G 1/065

(57) ABSTRACT

An access station for an automated storage and retrieval system includes a frame structure; and a drawer arranged in the frame structure. The drawer is a tilt drawer including a compartment for accommodating a goods holder. The tilt drawer is pivotable between a receiving position for receiving a goods holder from above, and a tilted picking position for presenting a goods holder to a user.

### FIELD OF THE INVENTION

The present invention relates to an automated storage and retrieval system for storage and retrieval of containers, in particular to an access station for presentation of a storage container from an automated storage and retrieval system to a user.

### BACKGROUND AND PRIOR ART

FIG. 1 discloses a prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not visible in the figure.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=7 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=5. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

In WO201/7211596 a storage system for storing product items is disclosed. The storage system comprises a grid structure and a number of storage bins configured to be stored in vertical compartments in the grid structure. Each storage bin is configured to contain at least one product item. The storage system comprises a picking and/or supply station where a product item is configured to be picked from one of the storage bins and/or where a product item is configured to be supplied to one of the storage bins. The picking and/or supply station comprises a drawer device, where the drawer device comprises a storage container with a compartment for temporarily storing a product item to be picked from or supplied to the storage system. The drawer device is configured to be in a closed state or in an open state; where a person is prevented from accessing the compartment in the closed state and where the person is allowed to access to the compartment in the open state.

It is an objective of the present invention to make an access station of the above-mentioned type more robust.

### SUMMARY OF THE INVENTION

The present invention is set forth and characterized in the independent claims, while the dependent claims describe other characteristics of the invention.

The present invention relates to an access station for an automated storage and retrieval system, wherein the access station comprises:
a frame structure; and
a drawer arranged in the frame structure, wherein the drawer is a tilt drawer comprising a compartment for accommodating a goods holder,

wherein the tilt drawer is pivotable between a receiving position for receiving a goods holder from above, and a tilted picking position for presenting a goods holder to a user.

It is thus provided an access station with few moving components. The pivoting motion requires few surfaces to slide against each other and thus less wear. The maintenance requirements of the access station will thus be minimal.

If an external load is applied the tilt drawer in the picking position, e.g. from a person sitting on the tilt drawer, the external load will be distributed more evenly between the frame structure and the tilt drawer as compared to a sliding draw arrangement. Sitting on the tilt drawer would also only be possible when the tilt drawer is in the tilted picking position. This access station is therefore less susceptible to vandalism.

This access station is therefore particularly suited for use as a pickup point accessible to the public, for instance as a curbside pickup point, one which is placed at the exterior of a building/warehouse etc.

The access station may comprise pivotal connection means connecting the tilt drawer to the frame structure. The pivotal connection between the tilt drawer and the frame structure may define the tilt drawer's axis of rotation. The pivotal connection may be one shaft extending through the tilt drawer to connect at opposite sides of the frame structure.

The goods holder may e.g. be a storage container, a bin, a tote, a pallet, a tray or similar.

Alternatively, the pivotal connection may be studs connecting the tilt drawer to the frame structure. Alternatively, the pivotal connection may be curved runners.

The tilt drawer preferably has an open top.

The receiving position may preferably be arranged in an interior of the frame structure.

The receiving position preferably has an upright orientation. However, the receiving position may have a tilted orientation if it is less tilted than the picking position.

Alternatively, the tilt drawer has an open side such that goods holders can be received from a side.

In one aspect, the tilt drawer may have a horizontal axis of rotation arranged under the middle of the tilt drawer. More preferred, the axis of rotation may be arranged at a lower end of the tilt drawer.

The tilt drawer's axis of rotation is preferably arranged above the base of the frame structure.

It is thus achieved a tilt drawer wherein the part of the tilt drawer above the middle (i.e. an upper part) has a longer movement than the part of the tilt drawer below the middle (i.e. a lower part) when the tilt drawer is tilted. The upper part of the tilt drawer may then move at least partly outside the frame structure while the lower part of the tilt drawer stays inside the frame structure, also when the base of the tilt drawer and the base of the frame structure substantially has the same size.

In one aspect, the tilt drawer may have a horizontal axis of rotation arranged in a horizontal central part of the tilt drawer and/or the frame structure.

By having a horizontal axis of rotation arranged in a horizontal central part (i.e. a part with a horizontal distance to the vertical side surfaces) of the tilt drawer and/or the frame structure, the vertical gap between the frame structure and the tilt drawer can be kept at a minimum when the tilt drawer is in the receiving position.

The compartment of the tilt drawer may be inaccessible to the user when in the receiving position.

It is achieved an ergonomic picking position for the user (i.e. a picker or consumer) as a goods holder comprised in the tilt drawer will be tilted in the picking position.

The tilt drawer (and thus also the goods holder) will have only a short distance of travel between the receiving position and the tilted picking position. A goods holder accommodated in the compartment of the tilt drawer will have partly overlapping positions when in the receiving position and in the tilted picking position. It is therefore achieved an access station with a small footprint, also when opened. The access station will take up a minimum space of its surroundings. It can thus be located on a pavement area, in a foyer of a public building or on a public square without interfering with the pedestrians.

In one aspect, the access station may be configured for vertical alignment of the receiving position with a port column of the automated storage and retrieval system for receiving goods holder therefrom.

A container handling vehicle may then lower a goods holder through the port column and into a compartment in the receiving position or retrieve a goods holder from a compartment in the receiving position via the port column.

A compartment in the receiving position may preferably be inaccessible from an exterior of the frame structure. A user would thus not be able to access the content of the compartment (i.e. a goods holder positioned in the compartment) when the compartment is in the receiving position.

In one aspect, the tilt drawer may be biased towards the receiving position.

This will allow continued operation of the access station in cases when the user forgets to close the tilt drawer after picking. This is particularly relevant when the user is not trained in using the access station and typically only has one picking to perform.

The biasing means may be a spring, a damper, a clump weight situated as appropriate in the tilt drawer or any combinations thereof. The biasing means may be arranged in a lower part of the tilt drawer.

In one aspect, the tilt drawer may be automated.

The access station may comprise one or several sensors in communication with a control system. A sensor may be configured to detect the presence of a goods holder in the compartment of the tilt drawer. A sensor may be configured to detect the position of the tilt drawer.

The access station may comprise an electric motor configured to operate the tilt drawer between the picking position and the receiving position. The electric motor may be controlled by a control system. The control system may receive signals from sensors in the access station or from remotely operated vehicles delivering and retrieving goods holders to/from the access station.

In one aspect, the frame structure and/or the tilt drawer may be configured to prevent retrieval of a goods holder from the compartment when the tilt drawer is in the picking position.

This will prevent vandals from stealing goods holders from the system when the access station is used as a curbside pickup point.

In one aspect, the access station may comprise a tilt limiter configured to limit pivotal movement of the tilt drawer beyond the picking position.

The tilt limiter may be configured to cause engagement between the drawer device and the frame structure at a predetermined point of the pivotal movement, such that further pivotal movement is prevented. The predetermined point of the pivotal movement will typically be the picking position.

In one aspect, the tilt limiter may be arranged on the tilt drawer.

The predetermined position is preferably set such that the frame structure at least partly obstructs access to the compartment when the tilt drawer is in this position. By limiting the available access opening of the compartment to an area smaller than external dimensions of a goods holder, retrieval of a goods holder from the compartment is prevented.

This will prevent vandals from stealing goods holder from the system when the access station is used as a curbside pickup point.

Alternatively, a tilt limiter may be arranged at the bottom (i.e. the foot) of the drawer. The tilt limiter will then abut the floor of the frame structure after a predetermined tilting.

Alternatively, a tilt limiter may be arranged on the frame structure.

The tilt drawer has a tilting angle α between the receiving position and the picking position.

The tilting angle α may range from 15° to 60° relative to a horizontal plane P_{H}, more preferably from 20° to 55°, even more preferably from 25° to 50°, even more preferably from 30° to 45°, even more preferably from 35° to 40°, for example 32.5°.

A preferred tilting angle range is 30° to 40°. Alternatively, this range may have a starting point of 10°, 15°, 20°, 25°, 30°, 35°. Alternatively, this range may have an end point of 35°, 40°, 45°, 50°, 55°, 60°.

The tilt limiter may be arranged on the tilt drawer and configured to extend upwardly relative to the tilt drawer. The tilt limiter may be a separate item connected to the tilt drawer or be made part of (i.e. integral with) the tilt drawer. The tilting angle may then be set by the length of the tilt limiter.

The tilt limiter is preferably configured to not obstruct the alignment of the compartment of the tilt drawer with a column of the frame structure when the tilt drawer is located in the receiving position.

A blocker may be configured to be located between two upright members of the frame structure when the tilt drawer is located in the receiving position. The tilt limiter may additionally serve this purpose if located in the upper part of the drawer. The blocker may prevent movement of the gripping device close to the compartment of the tilt drawer when the tilt drawer is not in the receiving position.

The present invention also relates to an automated storage and retrieval system, wherein the automated storage and retrieval system comprises:
an access station according to any one of the preceding claims;
a rail system comprising a first set of parallel rails arranged in a horizontal plane and extending in a first direction and a second set of parallel rails arranged in the horizontal plane and extending in a second direction which is orthogonal to the first direction, which first and second sets of rails form a grid in the horizontal plane comprising a plurality of adjacent access openings;
a storage section comprising a plurality of goods holder arranged in storage columns located beneath the rail system,

wherein each storage column is located vertically below one of the plurality of access openings;
at least one port column located beneath the rail system and vertically aligned with a receiving position of the access station, the at least one port column being void of goods holder; and
a container handling vehicle comprising a gripping device for lifting goods holder stored in the columns above the storage section and drive means configured to drive the vehicle along the rail system in at least one of the first direction and the second direction.

In one aspect, the access station may be configured to provide a lower section of the port column.

In one aspect, the automated storage and retrieval system may comprise:
at least two access stations, preferably three or four access stations.

The plurality of access stations may preferably be arranged side by side on a pavement area, in a foyer of a public building or on a public square, ideally positioned without interfering with the pedestrians. The access station may also be part of a commercial building (e.g. a grocery or other store). The access station may also be positioned on a commercial site (e.g. at a garden nursery dispensing plants, etc.). The access station may also be part of a large vending machine. The access station may be part of a bag storage.

One access station may also comprise a plurality of tilt drawers arranged side-by-side in the frame structure.

The present invention also relates to a method of presenting a goods holder at an access station using an automated storage and retrieval system as described herein, wherein the method comprises the steps of:
retrieving a goods holder stored in the storage section of the storage and retrieval system by means of a container handling vehicle comprising a gripping device;
moving a tilt drawer of the access station to a receiving position;
placing the goods holder in a compartment of the tilt drawer; and
tilting the tilt drawer into a picking position to present the goods holder to the user.

Placing the goods holder in the compartment of the tilt drawer is typically performed by lowering.

In one aspect, the method, after presenting the goods holder to the user, may further comprise the steps of:
returning the tilt drawer to the receiving position; and
retrieving the goods holder from the compartment.

Receiving the goods holder from the compartment may be performed by means of the gripping device.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view of a prior art container handling vehicle having an internally arranged cavity for carrying storage containers therein;

FIG. 5 is a perspective view of a storage container and product items stored in the storage container;

FIG. 6a is a perspective view of the access station. The access station comprises a frame structure and a tilt drawer with a compartment for a goods holder, wherein the tilt drawer is located in a receiving position;

FIG. 6b is a perspective view of the access station of FIG. 6a wherein the tilt drawer is located in the picking position;

FIG. 7a is a horizontal cross-section of the access station of FIG. 6a. The access station comprises a frame structure and a tilt drawer with a compartment for a goods holder, wherein the tilt drawer is located in a receiving position and a goods holder is positioned in the compartment of the tilt drawer by means of a gripping device;

FIG. 7b is a perspective view of a horizontal cross-section of the access station of FIG. 7a without the gripping device;

FIG. 8a is a horizontal cross-section of the access station of FIG. 6a wherein the tilt drawer is located partly outside the receiving position and the gripping device is elevated above the tilt drawer;

FIG. 8b is a perspective view of a horizontal cross-section of the access station of FIG. 8a without the gripping device;

FIG. 9a is a horizontal cross-section of the access station of FIG. 6a wherein the tilt drawer is located in a picking position;

FIG. 9b is a perspective view of a horizontal cross-section of the access station of FIG. 9a without the gripping device;

FIG. 10a is a horizontal cross-section of an access station, the access station comprises a tilt drawer and a frame structure with a tilt limiter, wherein the tilt drawer is located in a receiving position and a goods holder is positioned in the compartment of the tilt drawer by means of a gripping device;

FIG. 10b is a perspective view of a horizontal cross-section of the access station of FIG. 10a without the gripping device;

FIG. 11a is a horizontal cross-section of the access station of FIG. 10a wherein the tilt drawer is located partly outside the receiving position and the gripping device is elevated above the tilt drawer;

FIG. 11b is a perspective view of a horizontal cross-section of the access station of FIG. 11a without the gripping device;

FIG. 12a is a horizontal cross-section of the access station of FIG. 10a wherein the tilt drawer is located in a picking position and prevented from further tilting by the tilt limiter; and

FIG. 12b is a perspective view of a horizontal cross-section of the access station of FIG. 12a without the gripping device;

FIG. 13 is a perspective view of a part of an automated storage and retrieval system, wherein the automated storage and retrieval system comprises a plurality of access stations, in particular three access stations are arranged side-by-side;

FIG. 14a is a top view of the automated storage and retrieval system of FIG. 13, wherein the tilt drawers are in their receiving positions and the receiving positions are vertically aligned with access openings of an above rail system; and

FIG. 14b is a top view of the automated storage and retrieval system of FIG. 13, wherein the tilt drawers are in their picking positions.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

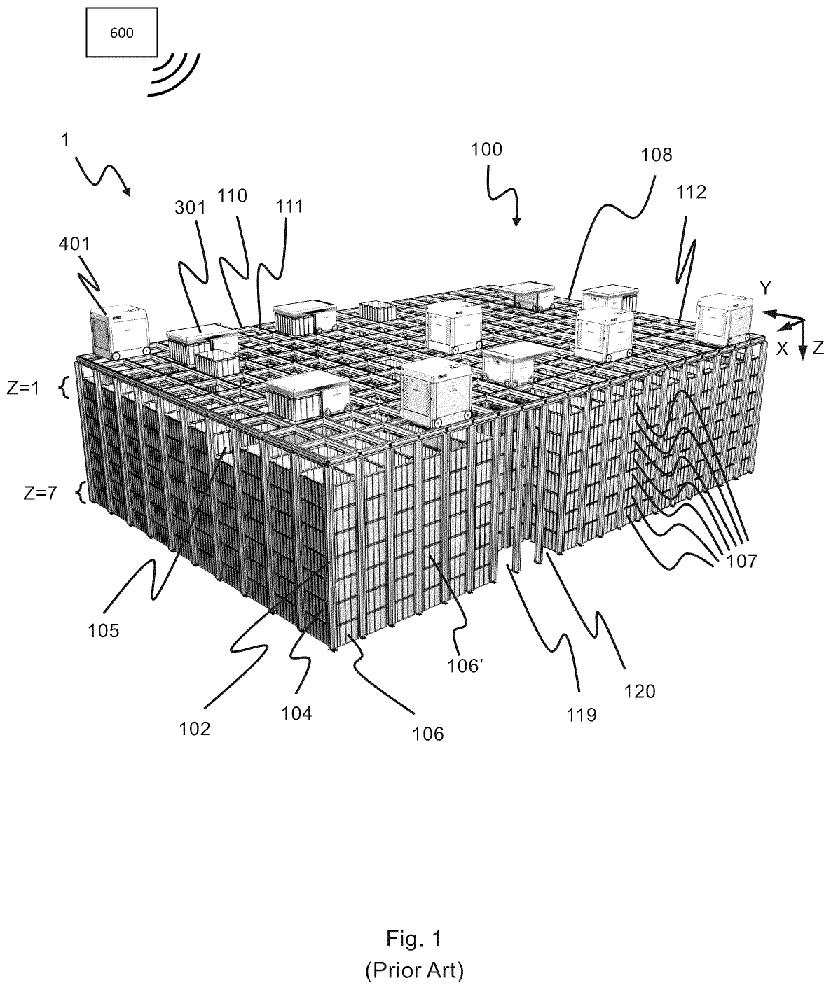

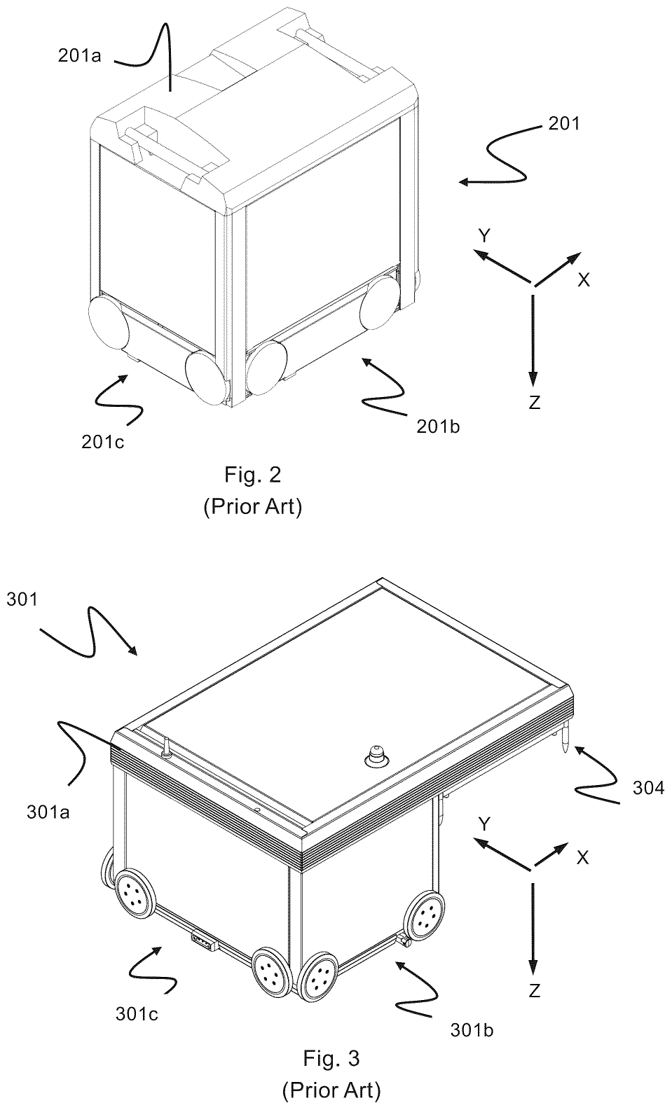

The framework structure 100 of the automated storage and retrieval system 1 is constructed in a similar manner to the prior art framework structure 100 described above in connection with FIGS. 1-3. That is, the framework structure 100 comprises a number of upright members 102, and further comprises a first, upper rail system 108 extending in the X direction and Y direction.

The framework structure 100 further comprises storage compartments in the form of storage columns 105 provided between the members 102, 103, wherein storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

One embodiment of the automated storage and retrieval system according to the invention will now be discussed in more detail with reference to Figs.

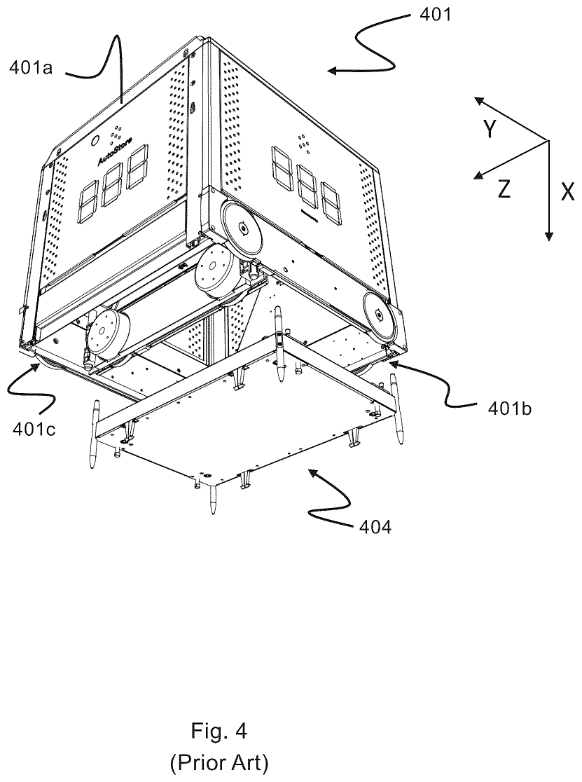

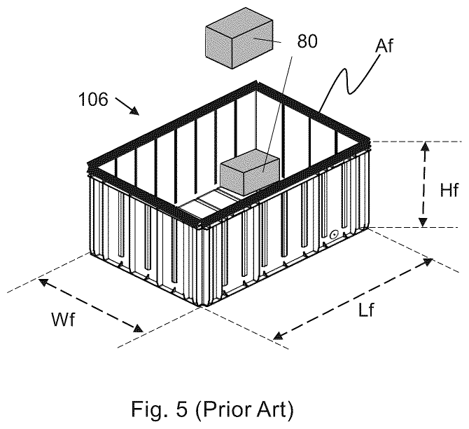

FIG. 5 shows examples of product items 80 stored in a storage container 106. The storage container 106 illustrated in FIG. 4 has a height Hf, a width Wf and a length Lf. The storage container 106 has a horizontal cross section Af.

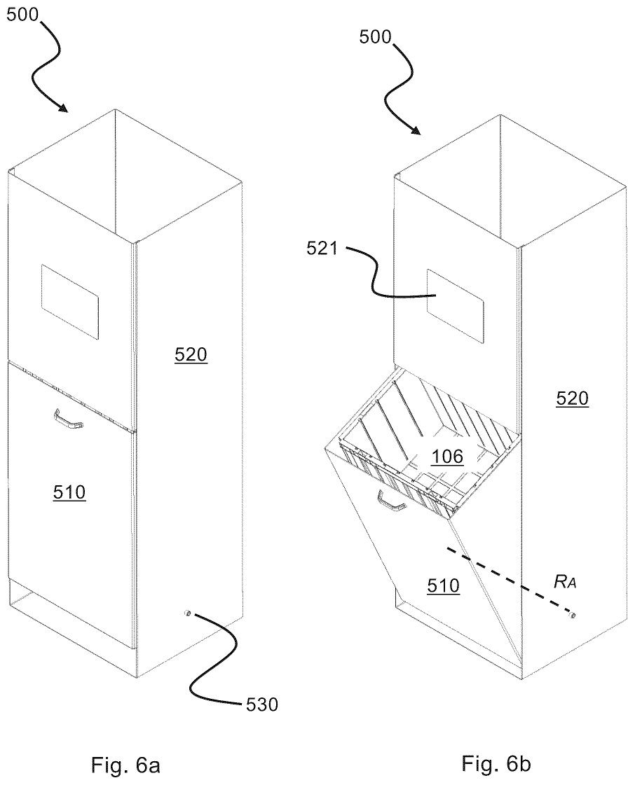

FIG. 6a shows a perspective view of an access station 500 suitable for an automated storage and retrieval system. The access station 500 comprises a frame structure 520, and a drawer in the form of a tilt drawer 510 arranged in the frame structure 520. The tilt drawer 510 comprises a compartment 511 suitable for accommodating a goods holder.

In FIG. 6a, the tilt drawer 510 is retracted in the frame structure 520. This position of the tilt drawer 510 may be referred to as a receiving position P_{R} as it allows a goods holder (such as a storage container 106, a bin, a tote, a pallet, a tray or similar) to be received in the compartment 511, typically from above. The access station 500 is preferably configured to prevent a user from accessing the compartment 511 when the tilt drawer 510 is in the receiving position P_{R}.

FIG. 6b is a perspective view of the access station of FIG. 6a. In FIG. 6b, the tilt drawer 510 is tilted out from the frame structure 520. In this position the tilt drawer 510 presents the compartment 511 (and thus also a goods holder positioned in the compartment 511) to an exterior of the frame structure 520. This position may be referred to as a picking position P_{P} as it allows a user of the access station 500 to access the compartment 511 and thus pick items 80 from a goods holder located in the compartment 511.

The tilt drawer 510 may be connected to the frame structure 520 by means of pivotal connection. The pivotal connection between the tilt drawer 510 and the frame structure 520 may define the tilt drawer's axis of rotation R_{A}. The pivotal connection may be achieved by means of pivotal connection means 530. The pivotal connection means 530 may e.g. be one shaft extending through the tilt drawer 510 to connect at opposite sides of the frame structure 520. Alternatively, the pivotal connection means 530 may be studs connecting the tilt drawer 510 to the frame structure 520.

As illustrated in FIG. 6b, the axis of rotation R_{A} may be arranged under the middle of the tilt drawer 510, particularly at a lower end of the tilt drawer 510. However, the axis of rotation R_{A} is preferably arranged above the base of the frame structure 520. In this way it is provided a gap between the lower end of the tilt drawer 510 and the base of the frame structure 520. The tilt drawer 510 is thus give some space to rotate in the frame structure 520.

It is thus achieved a tilt drawer 510 wherein the part of the tilt drawer 510 above the middle (i.e. an upper part) has a longer movement than the part of the tilt drawer 510 below the middle (i.e. a lower part) when the tilt drawer 510 is tilted. The upper part of the tilt drawer 510 may then move at least partly outside the frame structure 520 while the lower part of the tilt drawer 510 stays inside the frame structure 520, also when the base of the tilt drawer 510 and the base of the frame structure 520 substantially has the same size.

As illustrated in FIG. 6b, the axis of rotation R_{A} may be arranged in a horizontal central part of the tilt drawer 510 and/or the frame structure 520.

By having a horizontal axis of rotation R_{A} arranged in a horizontal central part (i.e. a part with a horizontal distance to the vertical side surfaces) of the tilt drawer 510 and/or the frame structure 520, the vertical gap between the frame structure and the tilt drawer can be kept at a minimum when the tilt drawer 510 is in the receiving position P_{R}. This will contribute in making the interior of the access station 500 less accessible to a user when the tilt drawer 510 is in the receiving position P_{R}.

As illustrated in FIG. 6b, the tilt drawer 510 may rotate around a horizontal axis of rotation R_{A}, allowing the tilt drawer 510 to pivot between the receiving position P_{R} and the picking position P_{P}. Alternatively, the pivotal connection may be curved runners (not illustrated).

The frame structure 520 may be an assembly of several components (such as beams, brackets, plates and/or rails) providing support to the tilt drawer 510. The frame structure 520 may additionally be configured to: enable the appropriate movement of the tilt drawer 510 between the receiving position P_{R} and the picking position P_{P}; provide the appropriate height of the tilt drawer 510; form at least a part of a port column above the tilt drawer 510; and/or define an interior of the access station 500 at least partly separated from an exterior of the access station 500. The interior of the access station 500 is preferably configured to accommodate the tilt drawer 510. The tilt drawer 510 may be configured to further separate the interior of the access station 500 from the exterior of the access station 500 when located in the receiving position P_{R}. By physically separating the interior of the access station 500 from the exterior of the access station 500, the risk of injury can be reduced for the user of the access station 500.

The access station 500 may be provided with a display 521. The display 521 will typically be used to provide information to the user of the access station 500.

The tilt drawer 510 has a rear end and a front end. The rear end of the tilt drawer 510 is typically facing a storage side of the access station 500 when connected to an automated storage and retrieval system, whereas the front end is typically facing a picking side of the access station 500. The picking side being accessible to users of the access station 500.

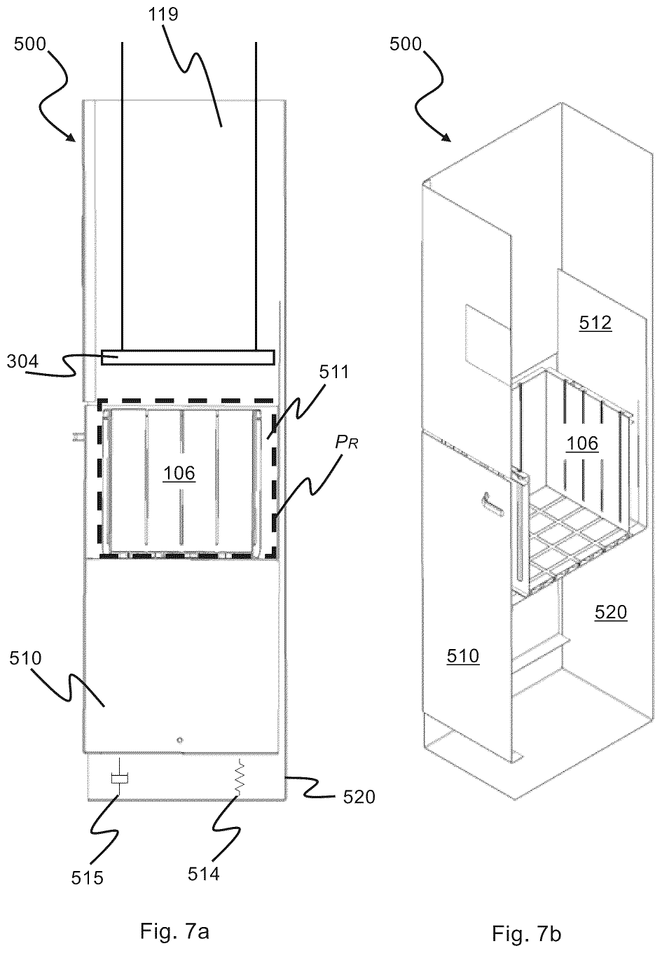

FIG. 7a shows a horizontal cross-section of the access station 500 of FIG. 6a, and FIG. 7b shows a perspective views of a horizontal cross-section of the access station of FIG. 7a without the gripping device 304.

In FIG. 7a-b, a goods holder in the form of a storage container 106 is placed in the compartment 511 of the tilt drawer 510 by means of a gripping device 304. The tilt drawer 510 is located in the receiving position P_{R} and the gripping device 304 is located directly above the tilt drawer 510.

In use, the tilt drawer 510 may be left in the picking position P_{P} by a user forgetting to rotate the tilt drawer 510 back to the receiving position P_{R}. This may be solved by a control system automatically returning the tilt drawer 510 to the receiving position P_{R} by means of an electric actuator or similar after a predetermined period of time. Alternatively, the tilt drawer 510 may be mechanically biased towards the receiving position P_{R}.

As illustrated in FIG. 7a, the tilt drawer 510 may be mechanically biased towards the receiving position P_{R} by means of a spring 514 connecting the rear end of the tilt drawer 510 to the base of the frame structure 520 and/or a damper 515 connecting the front end of the tilt drawer 510 and the base of the frame structure 520. Alternatively or additionally, the tilt drawer 510 may be mechanically biased towards the receiving position P_{R} by means of a clump weight 513 arranged in the rear end of the tilt drawer 510, as illustrated in FIG. 7b.

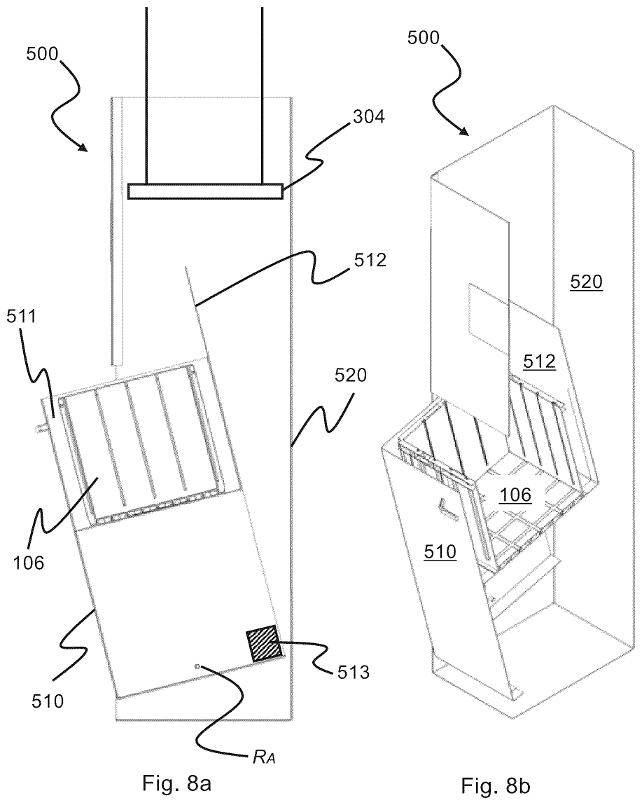

FIG. 8a shows a horizontal cross-section of the access station 500 of FIG. 7a, and FIG. 8b shows a perspective views of a horizontal cross-section of the access station of FIG. 8a without the gripping device 304.

In FIG. 8a-b, the tilt drawer 510 is located partly outside the receiving position P_{R} and the gripping device 304 is elevated above the tilt drawer 510.

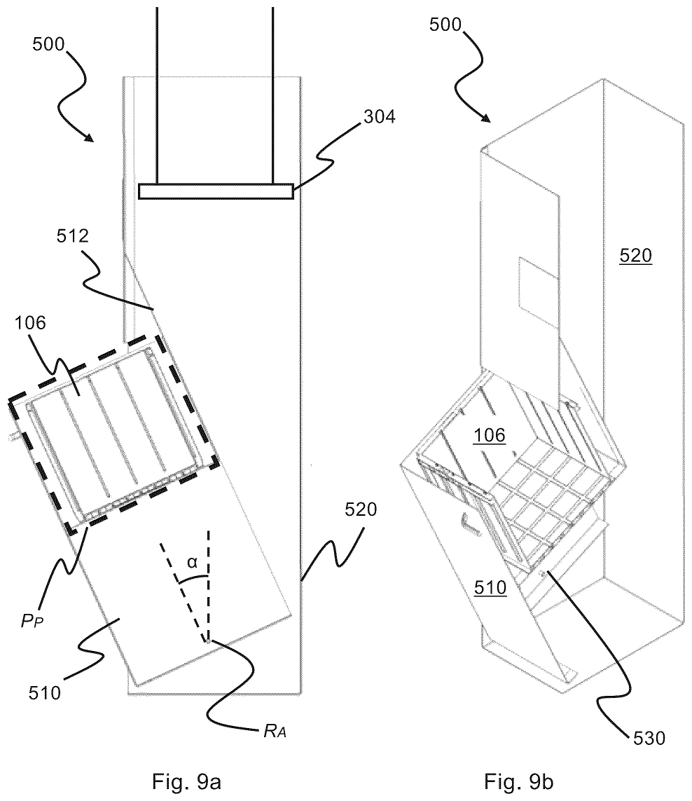

FIG. 9a shows a horizontal cross-section of the access station 500 of FIG. 7a, and FIG. 9b shows a perspective views of a horizontal cross-section of the access station of FIG. 9a without the gripping device 304.

In FIG. 9a-b, the tilt drawer 510 is located in the picking position P_{P} and the gripping device 304 is elevated above the tilt drawer 510.

When the tilt drawer 510′ is in the picking position P_{P}, as illustrated in FIG. 9a, the goods holder placed in the compartment 511 of the tilt drawer 510 is presented to a user of the access station 500. The user can then access the content of the goods holder. However, the user should preferably not be able to remove the goods holder from the tilt drawer 510. The frame structure 520 and/or the tilt drawer 510 may therefore be configured to prevent retrieval of a goods holder from the compartment 511 when the tilt drawer 510 is in the picking position P_{P}. This can be achieved by making the available opening of the tilt drawer 510 smaller in the picking position P_{P} than in the receiving position P_{R}, as illustrated in FIG. 9a and FIG. 7a respectively. The available opening in FIG. 9a is smaller than the size of the goods holder (i.e. the area A_{f} if the goods holder is a storage container 106), such that the goods holder cannot be retrieved from the tilt drawer 510 when the tilt drawer 510 is in the picking position P_{P}.

A handle may be arranged on the tilt drawer 510. The user of the access station 500 may use the handle to open and close the tilt drawer 510, i.e. move the tilt drawer 510 between the picking position P_{P} and the receiving position P_{R}.

As illustrated in FIG. 9a, the tilt drawer 510 may have a tilting angle α between the receiving position P_{R} and the picking position P_{P}. The tilting angle α may range from 15° to 60° relative to a horizontal plane P_{H}, more preferably from 20° to 55°, even more preferably from 25° to 50°, even more preferably from 30° to 45°, even more preferably from 35° to 40°, for example 32.5°.

A preferred tilting angle range is 30° to 40°. Alternatively, this range may have a starting point of 10°, 15°, 20°, 25°, 30°, 35°. Alternatively, this range may have an end point of 35°, 40°, 45°, 50°, 55°, 60°.

The access station 500 may comprise a tilt limiter 512, 522. The tilt limiter 512, 522 may be configured to cause engagement between the tilt drawer 510 and the frame structure 520 at a predetermined point of the pivotal movement, such that further pivotal movement of the tilt drawer 510 is prevented. The predetermined point of the pivotal movement will typically be the picking position P_{P}.

As illustrated in FIG. 9a-b, the tilt limiter 512 may be arranged on the tilt drawer 510.

The predetermined position is preferably set such that the frame structure 520 at least partly obstructs access to the compartment 511 when the tilt drawer 510 is in this position, such that a goods holder cannot be retrieved.

As illustrated in FIG. 9a-b, the tilt limiter 512 may be arranged on the tilt drawer 510 and configured to extend upwardly relative to the tilt drawer 510. The tilt limiter 512 may be a separate item connected to the tilt drawer 510 or be made part of (i.e. integral with) the tilt drawer 510. The tilting angle α may then be set by the length of the tilt limiter 512.

As illustrated in FIG. 7a-b, the tilt limiter 512 is preferably configured to not obstruct the alignment of the compartment 511 of the tilt drawer 510 with a column of the frame structure 520 when the tilt drawer is located in the receiving position P_{R}.

Alternatively, a tilt limiter may be arranged at the bottom of the front end (i.e. the foot) of the tilt drawer 510. The tilt limiter will then abut the base of the frame structure 520 after a predetermined tilting (not illustrated).

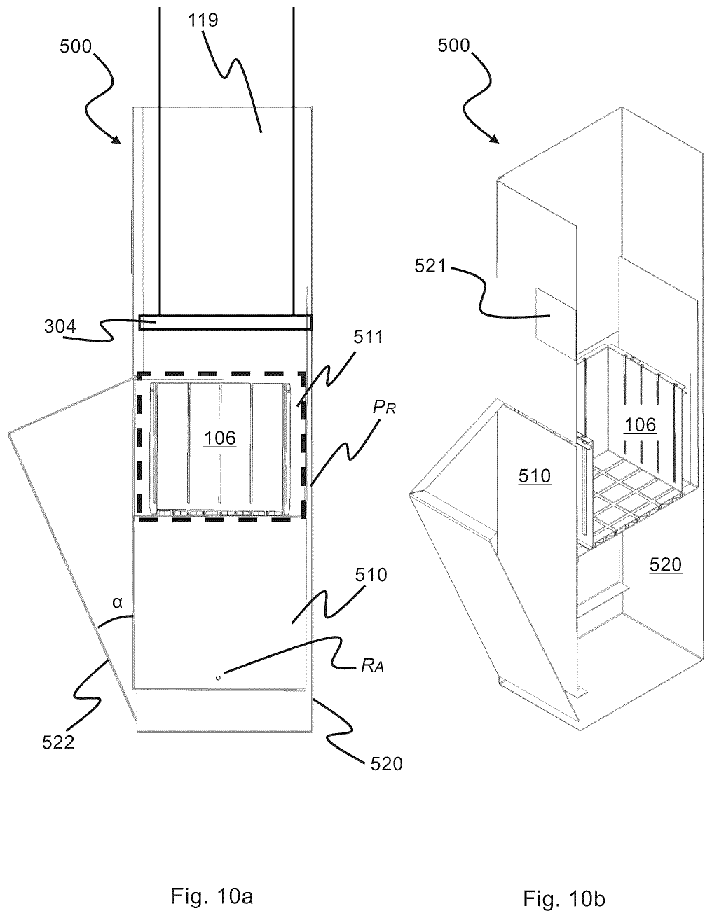

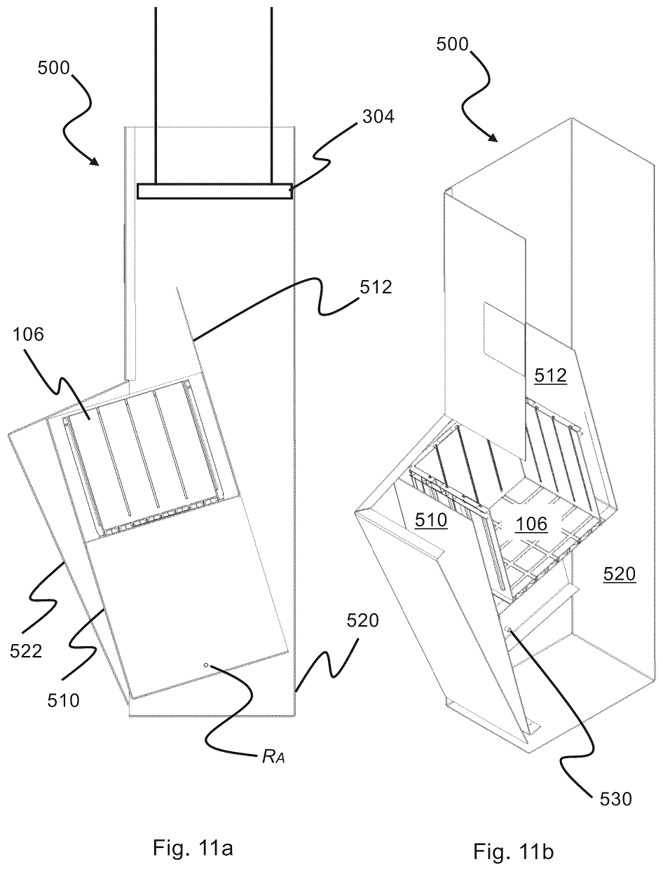

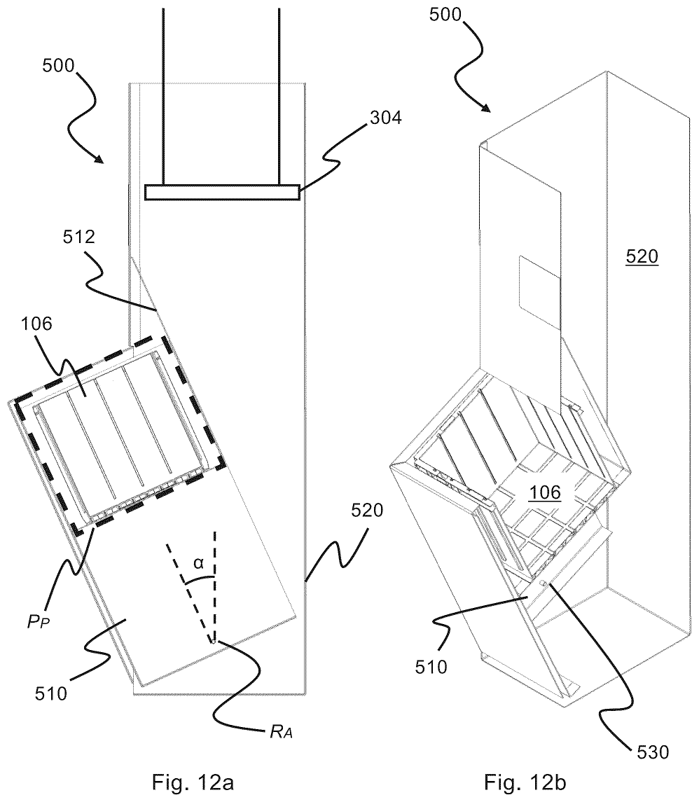

Alternatively, the tilt limiter 522 may be formed as a part of the frame structure 520 as illustrated in FIG. 10a-FIG. 12b.

As illustrated in FIG. 10a-FIG. 12b, the frame structure 520 may comprise a front panel being inclined relative to the vertical plane to form a tilt limiter 522 in front of the tilt drawer 520. The inclination of the front panel may typically correspond to the predetermined tilting angle α.

The tilt limiter 522 formed by the frame structure 520 may prevent objects being placed in front of the access station 500 in a way that the tilt drawer 510 cannot be opened.

The access station 500 of FIG. 10a-FIG. 12b may comprise any one of the features of the access station 500 of FIG. 7a-FIG. 9b.

The access station 500 may be automated, such that the tilt drawer 510 is automatically opened and closed, i.e. automatically moved between the receiving position P_{R} and the picking position P_{P}.

The access station 500 is preferably configured for vertical alignment of the receiving position P_{R} with a port column 119 of an automated storage and retrieval system. In that way a goods holder can be introduced from the port column 119 to the compartment 511 whilst the tilt drawer 510 is in the receiving position P_{R}.

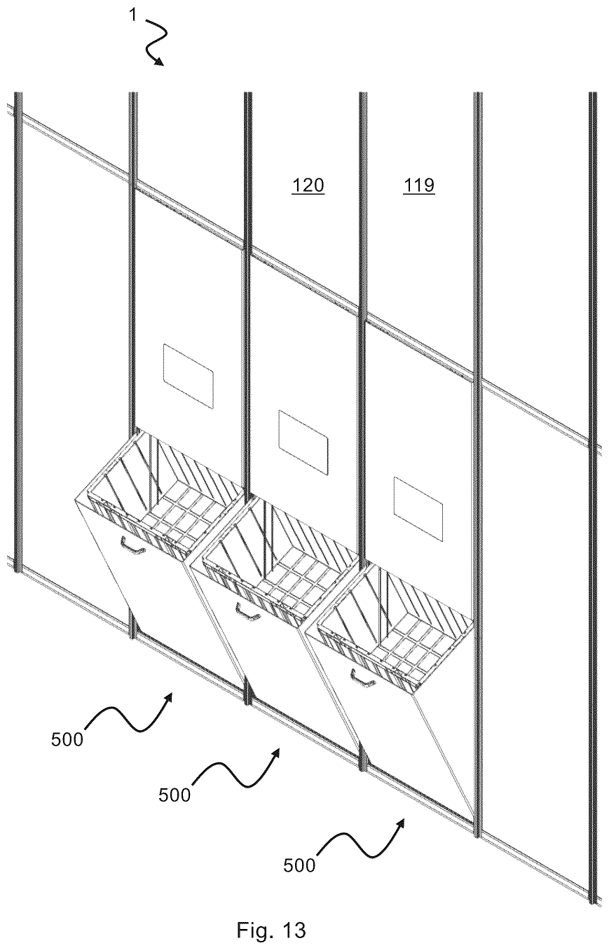

The frame structure 520 may form a part of a port column above the tilt drawer 510, as illustrated e.g. in FIG. 6a. The port column formed by the frame structure 520 is then preferable configured for vertical alignment with a port column 119 of an automated storage and retrieval system. The access station 500 can thus be configured to provide a lower section of the port column 119, as illustrated in FIG. 13.

The port column formed by the frame structure 520 and the port column 119 of the automated storage and retrieval system preferably have matching horizontal cross-sections. In that way the goods holders and the gripping device 304 configured for movement in the port column 119 of the automated storage and retrieval system will also be configured for movement in the port column formed by the frame structure 520.

An automated storage and retrieval system may comprise any one of the above described access stations 500 or any number and combinations of the above described access stations 500. The automated storage and retrieval system may additionally comprise a rail system 108, wherein the rail system comprises a first set of parallel rails 110 arranged in a horizontal plane P_{H} and extending in a first direction X and a second set of parallel rails 111 arranged in the horizontal plane P_{H} and extending in a second direction Y which is orthogonal to the first direction X, which first and second sets of rails 110, 111 form a grid in the horizontal plane P_{H} comprising a plurality of adjacent access openings 112. The automated storage and retrieval system may additionally comprise a storage section comprising a plurality of goods holders arranged in storage columns 105 located beneath the rail system 108, wherein each storage column 105 is located vertically below one of the plurality of access openings 112. The automated storage and retrieval system may additionally comprise at least one port column 119 located beneath the rail system 108 and vertically aligned with a receiving position P_{R} of the access station 400, the at least one port column 119 being void of goods holders. The automated storage and retrieval system may additionally comprise a container handling vehicle 201;301;401 comprising a gripping device 304 for lifting goods holders stored in the columns 105 above the storage section and drive means 201b,201c;301b,301c;401b,401c configured to drive the vehicle 301 along the rail system 108 in at least one of the first direction X and the second direction Y.

FIG. 13 is a perspective view of a part of an automated storage and retrieval system. As illustrated in FIG. 13, a plurality of access stations 500 may be arranged side-by-side as part of the same automated storage and retrieval system. In FIG. 13, three access stations 500 are arranged side-by-side, however, any other number of access stations 500 may be used in the same automated storage and retrieval system. The access stations 500 can be arranged side-by-side or spaced apart.

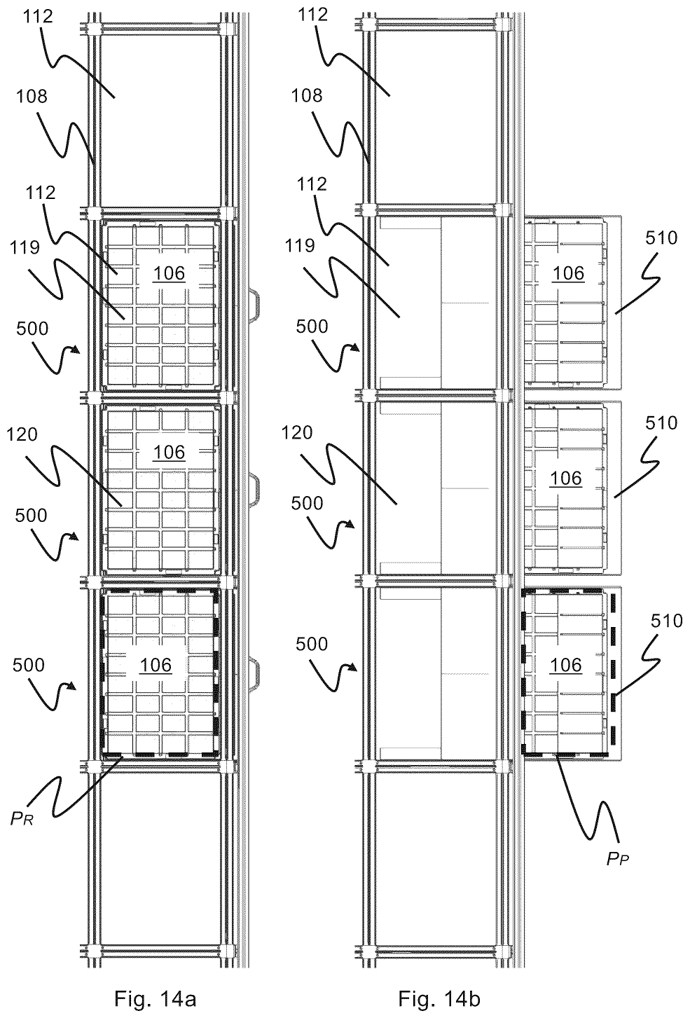

FIG. 14a is a top view of the automated storage and retrieval system of FIG. 13, wherein the tilt drawers 510 are in their receiving positions P_{R}. As illustrated in FIG. 14a, each of the receiving positions P_{R} may be vertically aligned with a port column 119,120 of the automated storage and retrieval system. As illustrated in FIG. 14a, each of the receiving positions P_{R} may be vertically aligned with access openings 112 in the rail system 108 of the automated storage and retrieval system. In this way the container handling vehicles 201;301;401 driving on the rail system 108 may deliver and retrieve goods holders to/from the access station 500.

FIG. 14b is a top view of the automated storage and retrieval system of FIG. 13, wherein the tilt drawers 510 are in their picking positions P_{P}. As illustrated in FIG. 14b, each of the picking positions P_{P} may not be vertically aligned with a port column 119,120 of the automated storage and retrieval system. The goods holders placed in the compartments 511 may thus not be accessible to the container handling vehicles 201;301;401 driving on the rail system 108.

The above described automated storage and retrieval system may be operated as follows:
retrieving a goods holder stored in the storage section of the storage and retrieval system by means of a container handling vehicle 201;301;401 comprising a gripping device 304;
moving a tilt drawer 510 of the access station 500 to a receiving position P_{R};
placing the goods holder in a compartment 511 of the tilt drawer 510;
tilting the tilt drawer 510 into a picking position P_{P} to present the goods holder to the user;
returning the tilt drawer 510 to the receiving position P_{R}; and
retrieving the goods holder from the compartment 511.

In the preceding description, various aspects of the delivery vehicle and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 Prior art automated storage and retrieval system
80 Product item
100 Framework structure
102 Upright members of framework structure
104 Storage grid
105 Storage column
106 Storage container
106′ Particular position of storage container
107 Stack
108 Rail system
110 Parallel rails in first direction (X)
111 Parallel rail in second direction (Y)
112 Access opening
119 First port column
120 Second port column
201 Prior art container handling vehicle
201a Vehicle body of the container handling vehicle 201
201b Drive means/wheel arrangement/first set of wheels in the first direction (X)
201c Drive means/wheel arrangement/second set of wheels in second direction (Y)
301 Prior art cantilever container handling vehicle
301a Vehicle body of the container handling vehicle 301
301b Drive means/first set of wheels in the first direction (X)
301c Drive means/second set of wheels in the second direction (Y)
304 Gripping device
401 Prior art container handling vehicle
401a Vehicle body of the container handling vehicle 401
401b Drive means/first set of wheels in first direction (X)
401c Drive means/second set of wheels in second direction (Y)
404 Gripping device
500 Access station
510 Tilt drawer
511 Compartment, for goods holder
512 Tilt limiter, of tilt drawer
513 Clump weight
514 Spring
515 Damper
520 Frame structure
521 Display
522 Tilt limiter, of frame structure
530 Pivotal connection means
600 Control system
X First direction
Y Second direction
Z Third direction
P_{R} Receiving position
P_{P} Picking position
Lf Length of storage container
Hf Height of storage container
Af Area of storage container
R_{A} Rotation axis
α Tilting angle

1. An access station for an automated storage and retrieval system, wherein the access station comprises:
a frame structure; and
a drawer arranged in the frame structure, wherein the drawer is a tilt drawer comprising a compartment for accommodating a goods holder,
wherein the tilt drawer is pivotable between a receiving position for receiving a goods holder from above, and a tilted picking position for presenting a goods holder to a user.

2. The access station according to claim 1,
wherein the tilt drawer has a horizontal axis of rotation arranged under a middle of the tilt drawer.

3. The access station according to claim 1,
wherein the tilt drawer has a horizontal axis of rotation arranged in a horizontal central part of the tilt drawer and/or the frame structure.

4. The access station according to claim 1,
wherein the access station is configured for vertical alignment of the receiving position with a port column of the automated storage and retrieval system for receiving goods holder therefrom.

5. The access station according to claim 1,
wherein the tilt drawer is biased towards the receiving position.

6. The access station according to claim 1,
wherein the access station comprises a tilt limiter configured to limit pivotal movement of the tilt drawer beyond the picking position.

7. The access station according to claim 6,
wherein the tilt limiter is arranged on the tilt drawer.

8. The access station (500) according to claim 1,
wherein the frame structure and/or the tilt drawer are configured to prevent retrieval of a goods holder from the compartment when the tilt drawer is in the picking position.

9. The access station according to claim 1,
wherein the tilt drawer is automated.

10. An automated storage and retrieval system comprising:
an access station for an automated storage and retrieval system, wherein the access station comprises:
a frame structure; and
a drawer arranged in the frame structure, wherein the drawer is a tilt drawer comprising a compartment for accommodating a goods holder,
wherein the tilt drawer is pivotable between a receiving position for receiving a goods holder from above, and a tilted picking position for presenting a goods holder to a user;
a rail system comprising a first set of parallel rails arranged in a horizontal plane and extending in a first direction and a second set of parallel rails arranged in the horizontal plane and extending in a second direction which is orthogonal to the first direction, which first and second sets of rails form a grid in the horizontal plane comprising a plurality of adjacent access openings;
a storage section comprising a plurality of goods holder arranged in storage columns located beneath the rail system,
wherein each storage column is located vertically below one of the plurality of access openings;
at least one port column located beneath the rail system and vertically aligned with a receiving position of the access station, the at least one port column being void of goods holder; and
a container handling vehicle comprising a gripping device for lifting goods holder stored in the columns above the storage section and drive means configured to drive the vehicle along the rail system in at least one of the first direction and the second direction.

11. The automated storage and retrieval system according to claim 10,
wherein the access station is configured to provide a lower section of the port column.

12. The automated storage and retrieval system according to claim 10,
wherein the automated storage and retrieval system comprises:
at least two access stations.

13. A method of presenting a goods holder at an access station using an automated storage and retrieval system according to claim 10,
wherein the method comprises:
retrieving a goods holder stored in the storage section of the storage and retrieval system by means of a container handling vehicle comprising a gripping device;
moving a tilt drawer of the access station to a receiving position;
placing the goods holder in a compartment of the tilt drawer; and
tilting the tilt drawer into a picking position to present the goods holder to the user.

14. The method according to claim 13,
wherein the method, after presenting the goods holder to the user, further comprises:
returning the tilt drawer to the receiving position; and
retrieving the goods holder from the compartment.

15. The automated storage and retrieval system according to claim 10,
wherein the automated storage and retrieval system comprises:
at least three access stations.

16. The automated storage and retrieval system according to claim 10,
wherein the automated storage and retrieval system comprises:
at least four access stations.
